(19) United States
(12) Patent Application Publication
(10) Pub. No.: US 2026/0291122 A1
(43) Pub. Date: Sep. 24, 2026

(54) CONNECTOR UNIT

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Teruo HARA, Mie (JP); Takae IMAYOSHI, Mie (JP)

(21) Appl. No.: 18/873,332

(22) PCT Filed: Jun. 2, 2023
(86) PCT No.: PCT/JP2023/020635

§ 371 Date: Dec. 10, 2024

(30) Foreign Application Priority Data
Jun. 13, 2022 (JP) 2022-094972

(51) Int. Cl. H01R 13/533; H01R 13/502; H01R 13/52; H01R 13/627; H01R 13/633; H01R 24/20; H01R 105/00

(52) U.S. Cl. CPC H01R 13/533; H01R 13/5025; H01R 13/5202; H01R 13/6272; H01R 13/6335; H01R 24/20; H01R 2105/00

(57) ABSTRACT

A connector unit 100 of the present disclosure comprises a mating connector 50 and a connector 10. A mating housing 60 includes a mating hood portion with a forward opening. A housing 20 includes a hood portion 22 that can be fitted over the mating hood portion, a tower portion 23 that can be fitted inside the mating hood portion, and a coupling portion 21 connecting the rear end of the hood portion 22 and the rear end of the tower portion 23. The tower portion 23 includes: a terminal housing portion 26 that is shaped to protrude forward beyond the front end of the hood portion 22, and in which a terminal 11 is housed; and an electric wire housing portion 24 that is continuous rearwardly with the terminal housing portion 26, and in which an electric wire 12 connected to the terminal 11 is housed. In a state in which the mating housing 60 and the housing 20 are mated with each other, the mating hood portion is disposed to surround the outer periphery of the electric wire housing portion 24, with the front end of the mating hood portion positioned at the rear end portion of the housing 20.

### TECHNICAL FIELD

The present disclosure relates to a connector unit.

### BACKGROUND

A connector described in Japanese Patent Laid-Open Publication No. 2019-125545 (Patent Document 1 below) is known as a connector used in a vibration environment. The connector is provided with a plurality of female terminal fittings, a housing, a retainer and a sealing member. The housing is made of synthetic resin and includes a housing body portion with a plurality of cavities, into which the plurality of female terminal fittings are insertable, a tubular fitting tube portion surrounding the outer periphery of the housing body portion, and a coupling portion extending in a radial direction to couple the fitting tube portion and the housing body portion. A part located on a rear side across the coupling portion, out of the housing body portion, includes a cavity tower portion having a chained cylindrical shape laterally continuous in a row while defining the respective cavities. The female terminal fitting includes a wire barrel portion connected to an end part of a wire and an insulation barrel portion crimped and connected to an individual rubber plug externally fit to the wire. The rubber plug is accommodated in a compressed state in the cavity tower portion.

A mating connector connectable to the above connector is provided with a plurality of male terminal fittings, and a mating housing. The mating housing is made of synthetic resin and includes a tubular receptacle projecting forward. If the connector is connected to the mating connector, the receptacle is fit between the fitting tube portion and the housing body portion and the male terminal fittings and the female terminal fittings are electrically connected.

### PRIOR ART DOCUMENT

### Patent Document

Patent Document 1: JP 2019-125545 A

### SUMMARY OF THE INVENTION

### Problems to be Solved

However, since a wire accommodating portion projects further rearward than the tip of the receptacle fit between the fitting tube portion and the housing body portion in the above connector, a center of gravity of the entire assembly of the connector and the mating connector tends to be located on a rear side of the connector and a displacement amount of a connector rear end increases during resonance. That is, if a part not fit to the receptacle of the mating connector, out of the housing, is large in a connected state, this part is easily displaced during resonance. On the other hand, a displacement of a part fit to the receptacle of the mating connector, out of the housing, is easily suppressed even during resonance since the vibration of the mating connector and that of the connector are integrated. As just described, there has been a room for further improvement to improve the vibration resistance of the connector.

### Means to Solve the Problem

The present disclosure is directed to a connector unit with a mating connector including a mating housing and a connector including a housing connectable to the mating housing, if a connection surface of the mating housing and a connection surface of the housing face each other when the mating housing and the housing are connected and the connection surface sides of the mating housing and the housing are defined as front sides, the mating housing including a mating receptacle open forward, the housing including a receptacle externally fittable to the mating receptacle, a tower portion fittable into the mating receptacle and a coupling portion coupling a rear end of the receptacle and a rear end of the tower portion, the tower portion including a terminal accommodating portion formed to project further forward than a front end of the receptacle, the terminal accommodating portion accommodating a terminal inside, and a wire accommodating portion connected to a rear side of the terminal accommodating portion, the wire accommodating portion accommodating a wire connected to the terminal inside, and a front end of the mating receptacle being located in a rear end part of the housing if the mating receptacle is arranged to surround an outer periphery of the wire accommodating portion with the mating housing and the housing connected.

### Effect of the Invention

According to the present disclosure, the vibration resistance of a connector unit can be improved.

### BRIEF DESCRIPTION OF THE DRAWINGS

FIG. 1 is a perspective view of a connector unit.

FIG. 2 is an exploded perspective view of the connector unit.

FIG. 3 is a longitudinal section showing the internal structure of the connector unit.

FIG. 4 is a transverse section showing the internal structure of the connector unit.

FIG. 5 is a front view of a connector.

FIG. 6 is a side view of the connector.

FIG. 7 is a front view of a mating connector.

### DETAILED DESCRIPTION TO EXECUTE THE INVENTION

### Description of Embodiments of Present Disclosure

First, embodiments of the present disclosure are listed and described.

(1) The connector unit of the present disclosure is provided with a mating connector including a mating housing and a connector including a housing connectable to the mating housing, if a connection surface of the mating housing and a connection surface of the housing face each other when the mating housing and the housing are connected and the connection surface sides of the mating housing and the housing are defined as front sides, the mating housing including a mating receptacle open forward, the housing including a receptacle externally fittable to the mating receptacle, a tower portion fittable into the mating receptacle and a coupling portion coupling a rear end of the receptacle and a rear end of the tower portion, the tower portion including a terminal accommodating portion formed to project further forward than a front end of the receptacle, the terminal accommodating portion accommodating a terminal inside, and a wire accommodating portion connected to a rear side of the terminal accommodating portion, the wire accommodating portion accommodating a wire connected to the terminal inside, and a front end of the mating receptacle being located in a rear end part of the housing if the mating receptacle is arranged to surround an outer periphery of the wire accommodating portion with the mating housing and the housing connected.

According to the above connector unit, since the terminal accommodating portion is formed to project further forward than the front end of the receptacle and the front end of the mating receptacle is located in the rear end part of the housing, a center of gravity of the entire connector unit can be located more forward than before. In this way, a displacement of the entire connector unit during resonance can be suppressed more than the conventional connector unit.

Further, since a dimension of a part projecting further rearward than the front end of the mating receptacle, out of the housing, is the sum of a plate thickness of the coupling portion and a length in a front-rear direction of the wire accommodating portion in a connected state in the conventional connector, a displacement amount of a connector rear end is large during resonance. In contrast, since the mating receptacle is arranged to surround the outer periphery of the wire accommodating portion in the above connector, a dimension of a part projecting further rearward than the front end of the mating receptacle, out of the housing, is only a plate thickness of the coupling portion in the connected state, wherefore a rearward projection amount can be suppressed and an increase in the displacement amount of the connector rear end can be suppressed during resonance.

(2) Preferably, the receptacle has a tubular shape open forward and a thickened portion thickened to increase a thickness radially outward is provided on an opening edge part of the receptacle.

Since the thickened portion is provided on the opening edge part of the receptacle, the center of gravity of the entire connector unit can be located more forward.

(3) Preferably, the thickened portion includes a hand-grip portion increased in thickness toward a front side.

Since the thickened portion includes the hand-grip portion, fingers are easily hooked to the hand-grip portion and the thickened portion can be used as an operating portion during connection when the connector is connected to the mating connector. Further, since the center of gravity of the entire connector unit can be located more forward as compared to the case where the hand-grip portion is provided on the rear end of the housing, vibration resistance can be more improved.

### Details of Embodiment of Present Disclosure

A specific example of a connector unit of the present disclosure is described below with reference to the drawings. Note that the present disclosure is not limited to these illustrations, but is represented by claims and intended to include all changes in the scope of claims and in the meaning and scope of equivalents.

### EMBODIMENT

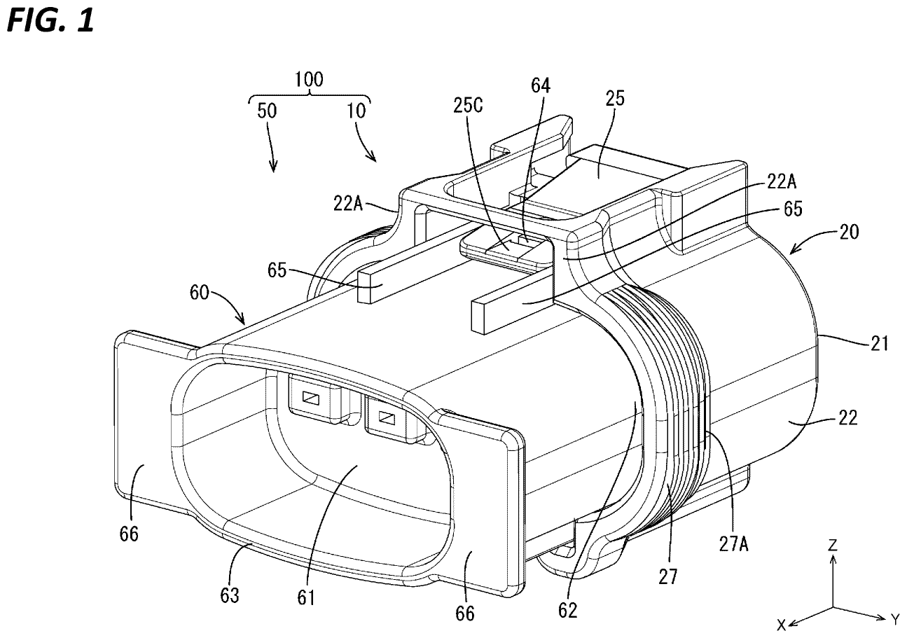

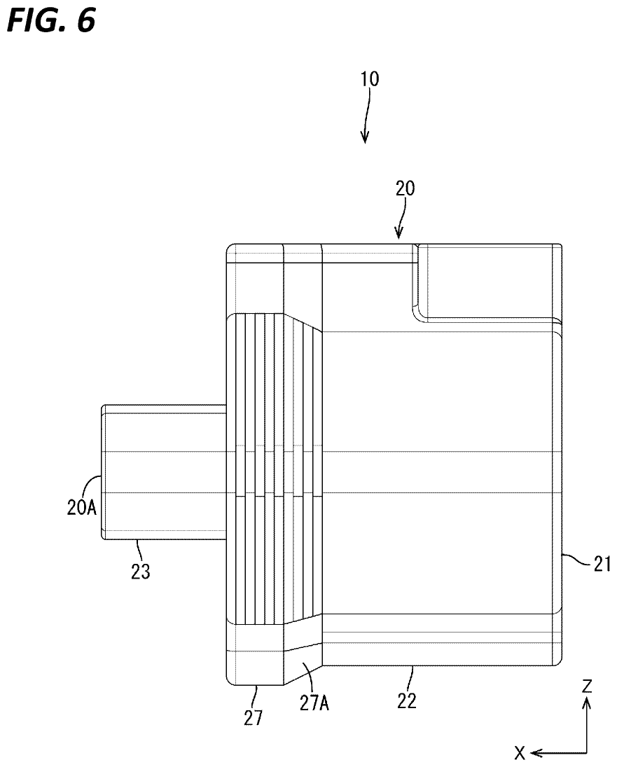

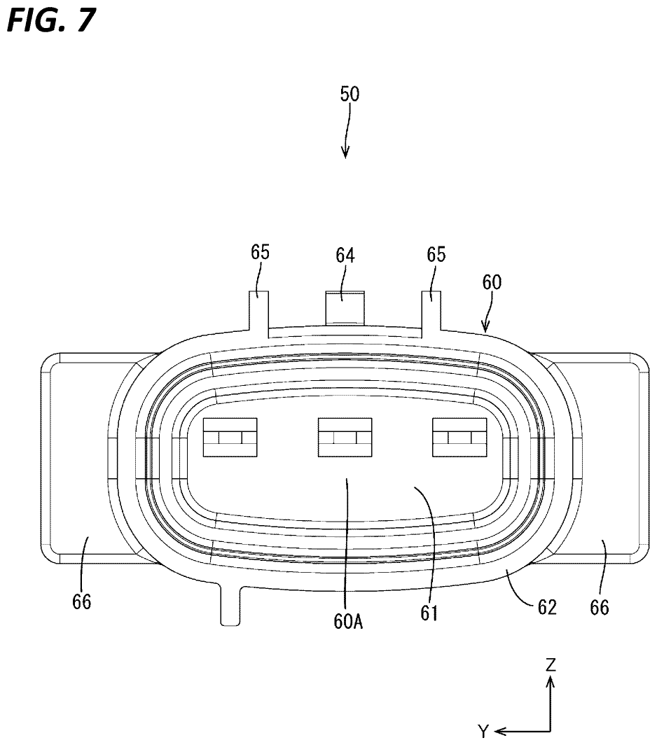

An embodiment of the present disclosure is described with reference to FIGS. 1 to 7. A connector unit 100 of this embodiment is provided with a mating connector 50 including a mating housing 60 and a connector 10 including a housing 20 connectable to the mating housing 60. In the following description, a direction indicated by an arrow Z is referred to as a vertical direction, a direction indicated by an arrow X is referred to as a front-rear direction and a direction indicated by an arrow Y is referred to as a lateral direction.

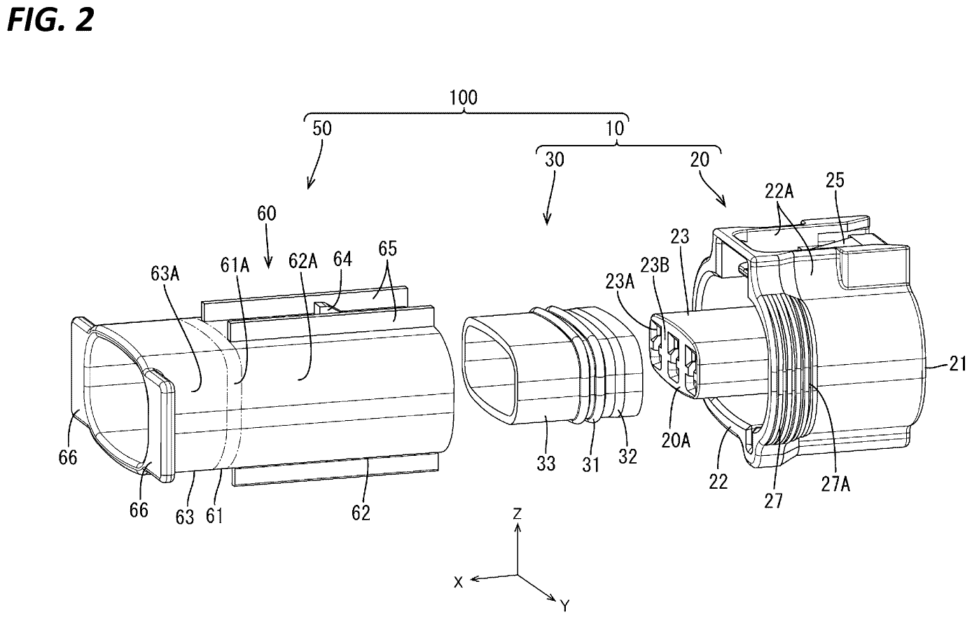

The connector 10 of this embodiment is provided with the housing 20 and a rubber plug 30 as shown in FIG. 2. The connector 10 is connectable to the mating connector 50. Here, a connection surface 60A of the mating housing 60 and a connection surface 20A of the housing 20 face each other in the front-rear direction when the mating housing 60 and the housing 20 are connected, and the sides of the connection surfaces 20A, 60A of the housing 20 and the mating housing 60 are defined as front sides. Note that, for a plurality of identical members, only some members may be denoted by a reference sign and the other members may not be denoted by the reference sign.

### Mating Connector

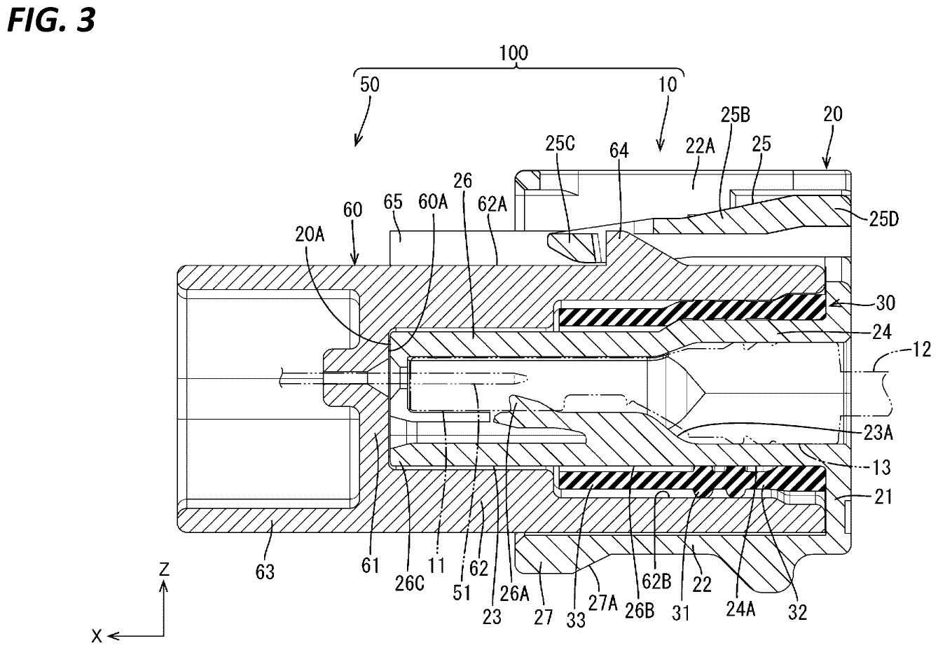

The mating connector 50 is provided with the mating housing 60 and mating terminals 51. The mating housing 60 is made of insulating synthetic resin and, as shown in FIG. 3, provided with a plate-like body portion 61, a front tube portion 62 extending forward from the peripheral edge of the body portion 61 and a rear tube portion 63 extending rearward from the peripheral edge of the body portion 61. The front tube portion 62 is in the form of a tubular receptacle open forward, and the back wall of the front tube portion 62 is constituted by the body portion 61. The rear tube portion 63 is in the form of a tubular receptacle open rearward, and the back wall of the rear tube portion 63 is constituted by the body portion 61.

As shown in FIG. 2, the front tube portion 62, the body portion 61 and the rear tube portion 63 are successively provided in this order. An outer peripheral surface 62A of the front tube portion 62, an outer peripheral surface 61A of the body portion 61 and an outer peripheral surface 63A of the rear tube portion 63 are continuous and flush with each other. A lock receiving portion 64A is provided on the outer peripheral surface 62A of the front tube portion 62. A pair of protection walls 65 are provided on both left and right sides of the lock receiving portion 64 on the outer peripheral surface 62A of the front tube portion 62. The rear end of the rear tube portion 63 is provided with a pair of flange portions 66 protruding in the lateral direction.

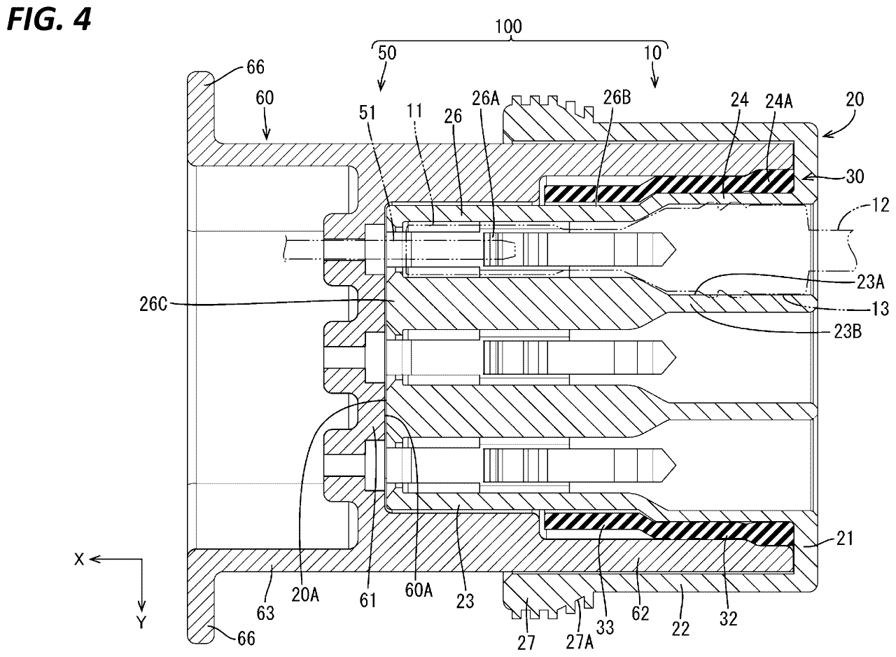

The mating terminal 51 is a male terminal made of metal and, as shown in FIGS. 3 and 4, tab-shaped. The mating terminal 51 is formed into a predetermined shape by a known method such as press working, cutting or casting. An arbitrary metal such as copper, copper alloy, aluminum, aluminum alloy or stainless steel can be appropriately selected as a metal constituting the mating terminal 51 if necessary. A plating layer may be formed on the surface of the mating terminal 51. An arbitrary metal such as tin, nickel or silver can be appropriately selected as a metal constituting the plating layer if necessary.

As shown in FIG. 3, the mating terminal 51 is held by the body portion 61 by being passed through the body portion 61 of the mating housing 60 in the front-rear direction. Out of the mating terminal 51, a part corresponding to the front tube portion 62 projects about ⅓ of the entire length in the front-rear direction of the front tube portion 62 from the body portion 61. Out of the mating terminal 51, a part corresponding to the rear tube portion 63 projects further rearward than the opening edge of the rear tube portion 63 from the body portion 61, although not shown.

### Connector

The connector 10 is provided with the housing 20, terminals 11 and the rubber plug 30. The housing 20 is made of insulating synthetic resin and, as shown in FIG. 3, provided with a plate-like coupling portion 21, a receptacle 22 extending forward from the peripheral edge of the coupling portion 21, a tower portion 23 extending forward from the coupling portion 21 inside the receptacle 22 and a lock arm 25 provided on the upper surface of the coupling portion 21. The coupling portion 21 couples the rear end of the receptacle 22 and the rear end of the tower portion 23. The receptacle 22 is externally fit to the front tube portion 62 of the mating housing 60, and the tower portion 23 is fit into the front tube portion 62 of the mating housing 60.

The terminal 11 is a female terminal made of metal and in the form of a rectangular tube. The terminal 11 is formed into a predetermined shape by a known method such as press working, cutting or casting. An arbitrary metal such as copper, copper alloy, aluminum, aluminum alloy or stainless steel can be appropriately selected as a metal constituting the mating terminal 11 if necessary. A plating layer may be formed on the surface of the mating terminal 11. An arbitrary metal such as tin, nickel or silver can be appropriately selected as a metal constituting the plating layer if necessary.

As shown in FIG. 2, the receptacle 22 is in the form of a tubular receptacle open forward. The back wall of the receptacle 22 is constituted by the coupling portion 21. Out of the receptacle 22, a part corresponding to the lock arm 25 bulges upward and is cut, leaving a front end part, and the lock arm 25 is entirely accommodated in this bulging part. Accordingly, the receptacle 22 includes a pair of protection walls 22A disposed on both left and right sides of the lock arm 25. With the connector 10 and the mating connector 50 connected, the pair of protection walls 65 of the mating housing 60 are accommodated inside the pair of protection walls 22A of the receptacle 22 as shown in FIG. 1.

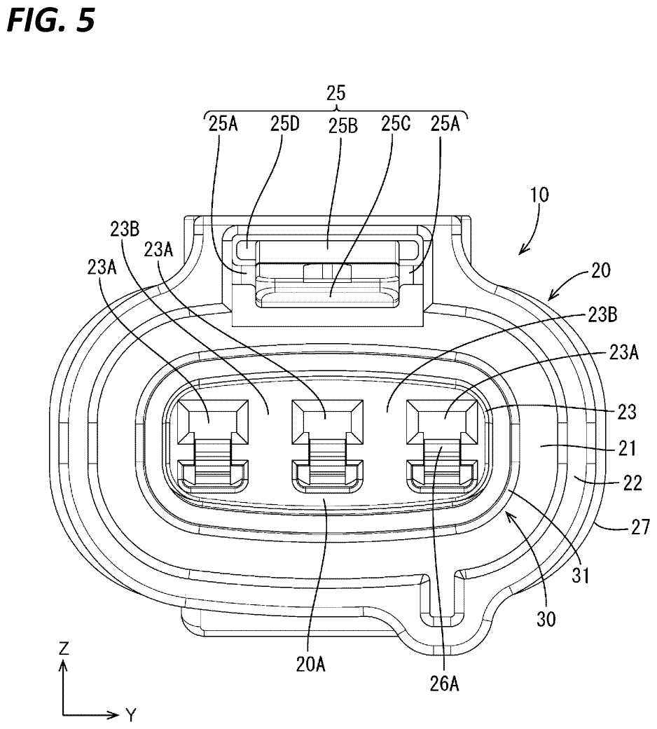

As shown in FIG. 5, the tower portion 23 has a substantially rectangular shape long in the lateral direction in a front view. The tower portion 23 includes at least a pair of (three in the present disclosure) cavities 23A open in the front-rear direction and partition walls 23B partitioning between a pair of adjacent cavities 23A.

The tower portion 23 includes a terminal accommodating portion 26 for accommodating the terminals 11 inside and a wire accommodating portion 24 connected to a rear side of the terminal accommodating portion 26 and configured to accommodate wires 12 connected to the terminals 11 inside. The cavities 23A and the partition walls 23B are provided from the front end of the terminal accommodating portion 26 to the rear end of the wire accommodating portion 24.

As shown in FIG. 3, the wire accommodating portion 24 accommodates the wires 12 connected to the terminals 11 and rubber plugs 13 externally fit to the wires 12. The wire 12 is such a known wire that a core wire made of an electrically conductive single core wire or metal thin wires is surrounded by an insulation coating. The rubber plug 13 is sandwiched between the insulation coating of the wire 12 and the inner peripheral surface of the wire accommodating portion 24, thereby preventing water entrance into the cavity 23A of the tower portion 23.

A bottom wall of the wire accommodating portion 24 is formed with locking lances 26A. The locking lance 26A is cantilevered and shaped to extend forward. If the terminal 11 is inserted into the cavity 23A from behind, the locking lance 26A is deflected and deformed downward. If the terminal 11 is inserted to a proper position in the terminal accommodating portion 26, the locking lance 26A returns to an original shape and locks the terminal 11. In this way, the terminal 11 is held in the cavity 23A in the terminal accommodating portion 26.

As shown in FIG. 5, the lock arm 25 includes a pair of base end parts 25A respectively connected to the pair of protection walls 22A, an arm portion 25B pivotable about the pair of base end parts 25A, a locking portion 25C formed in a front end part of the arm portion 25B and a releasing portion 25D formed in a rear end part of the arm portion 25B. The arm portion 25B is coupled to the pair of base end parts 25A at a position closer to a rear end than a center thereof.

If the connector 10 is connected to the mating connector 50, the locking portion 25C rides on the lock receiving portion 64, whereby the arm portion 25B resiliently pivots. If the locking portion 25C rides over the lock receiving portion 64, the arm portion 25B resiliently returns and the locking portion 25C locks the lock receiving portion 64. In this way, the connector 10 and the mating connector 50 are held in a connected state.

If the releasing portion 25D is pushed downward, the front end part of the arm portion 25B is pivoted and displaced upward and the locking of the locking portion 25° C. and the lock receiving portion 64 is released. The connector 10 and the mating connector 50 are separable by being pulled apart from each other in this locking released state.

### Rubber Plug

The rubber plug 30 is a resilient member made of synthetic rubber, natural rubber or the like and, as shown in FIG. 2, formed into a rectangular annular shape with rounded corners. The rubber plug 30 is provided with a tubular water stop portion 32 and a tubular vibration resistance portion 33 extending forward from the water stop portion 32. As shown in FIG. 3, the water stop portion 32 is externally fit to the wire accommodating portion 24 of the tower portion 23, and the vibration resistance portion 33 is externally fit to the terminal accommodating portion 26 of the tower portion 23.

The water stop portion 32 includes lips 31 seamlessly formed in a circumferential direction of the water stop portion 32. A plurality of (two in the present disclosure) the lips 31 are provided side by side in the front-rear direction. As shown in FIG. 3, the lip 31 includes a part projecting radially outward from the outer peripheral surface of the water stop portion 32 and a part projecting radially inward from the inner peripheral surface of the water stop portion 32. If the tower portion 23 is fit into the front tube portion 62 of the mating housing 60, the water stop portion 32 is sandwiched between an inner peripheral surface 62B of the front tube portion 62 and an outer peripheral surface 24A of the terminal accommodating portion 24, whereby the lips 31 are squeezed. That is, the lips 31 are held in close contact with both the inner peripheral surface 62B of the front tube portion 62 and the outer peripheral surface 24A of the terminal accommodating portion 24, whereby water is stopped between the front tube portion 62 and the tower portion 23.

The vibration resistance portion 33 is formed into a tubular shape extending forward along an outer peripheral surface 26B of the terminal accommodating portion 26 from the water stop portion 32. The front end of the vibration resistance portion 33 is located near half the entire length in the front-rear direction of the terminal accommodating portion 26. If a front end part 26C of the terminal accommodating portion 26 is going to vibrate about the lips 31, vibration is suppressed by the vibration resistance portion 33. In this way, the abrasion of a contact point of the terminal 11 and the mating terminal 51 due to vibration can be suppressed.

### Reason Why Vibration Resistance of Entire Connector Unit is Improved

As shown in FIG. 3, the front end of the front tube portion 62 of the mating housing 60 is located at the rear end of the connector 10 (front surface of the coupling portion 21) if the front tube portion 62 is arranged to surround the outer periphery of the wire accommodating portion 24 in the connected state. Thus, out of the housing 20, a part projecting further rearward than the front end of the front tube portion 62 is only the coupling portion 21. On the other hand, in the conventional connector described in Japanese Unexamined Patent Publication No. 2019-125545, since a part projecting further rearward than the front end of the receptacle, out of the housing, is composed of the coupling portion, the cavity tower portion (part accommodating the wires and the rubber plugs), a pair of arch portions and a bottom portion, the cavity tower portion, the pair of arch portions and the bottom portion are arranged extra to project rearward as compared to the connector 10 of the present disclosure. Therefore, a center of gravity of the connector 10 of the present disclosure is located more forward than the conventional connector and a displacement of the rear end of the connector 10 during resonance can be suppressed. Along with this, a center of gravity of the connector unit 10 composed of the connector 10 and the mating connector 50 is located more forward than the conventional connector and a displacement of the entire connector unit 100 can be suppressed.

The tower portion 23 is formed to project further forward than the front end of the receptacle 22. In this way, a fit part of the front tube portion 62 and the tower portion 23 is longer in the front-rear direction than in the conventional connector unit. Since the vibration of the housing 20 and the vibration of the mating housing 60 are integrated in the fit part, a displacement amount can be suppressed to be small also during resonance.

A thickened portion 27 thickened to increase a thickness radially outward is provided on an opening edge part of the receptacle 22. The center of gravity of the connector unit 100 is located more forward in the connector 10 also by this thickened portion 27, whereby a displacement of the entire connector unit 100 can be further suppressed.

Further, a rear end part of the thickened portion 27 is formed with a hand-grip portion 27A increased in thickness toward a front side. For example, by placing a thumb and an index finger on the hand-grip portion 27A and pushing the connector 10 toward the mating connector 50, a connecting operation is easily performed. Such a hand-grip portion 27A is formed as a step portion on a rear end part of the housing body portion in the conventional connector and has been a factor causing the center of gravity the connector to be located more rearward than the connector 10 of the present disclosure. In that respect, since the thickened portion 27 including the hand-grip portion 27A is formed on the front end part of the receptacle 22 in the connector 10 of the present disclosure, the center of gravity of the entire connector unit 100 can be located more forward than the conventional connector unit and a displacement during resonance can be further suppressed.

### Functions and Effects of Embodiment

The connector unit 100 of the present disclosure is provided with the mating connector 50 including the mating housing 60 and the connector 10 including the housing 20 connectable to the mating housing 60. If the connection surface 60A of the mating housing 60 and the connection surface 20A of the housing 20 face each other when the mating housing 60 and the housing 20 are connected and the sides of the connection surfaces 20A, 60A of the housing 20 and the mating housing 60 are defined as the front sides, the mating housing 60 includes the front tube portion 62 open forward and the housing 20 includes the receptacle 22 externally fittable to the front tube portion 62, the tower portion 23 fittable into the front tube portion 62 and the coupling portion 21 coupling the rear end of the receptacle 22 and the rear end of the tower portion 23. The tower portion 23 includes the terminal accommodating portion 26 projecting further forward than the front end of the receptacle 22 and configured to accommodate the terminals 11 inside, and the wire accommodating portion 24 connected to the rear side of the terminal accommodating portion 26 and configured to accommodate the wires 12 connected to the terminals 11 inside. The front end of the front tube portion 62 is located in the rear end part of the housing 20 if the front tube portion 62 is arranged to surround the outer periphery of the wire accommodating portion 24 with the mating housing 60 and the housing 20 connected.

According to the above connector unit 100, since the terminal accommodating portion 26 is formed to project further forward than the front end of the receptacle 22 and the front end of the front tube portion 62 is located in the rear end part of the housing 20, the center of gravity of the entire connector unit 100 can be located more forward than before. In this way, a displacement of the entire connector unit 100 during resonance can be suppressed more than the conventional connector unit.

Further, since a dimension of the part projecting further rearward than the front end of the mating receptacle, out of the housing, is the sum of a plate thickness of the coupling portion and a length in the front-rear direction of the wire accommodating portion in the connected state in the conventional connector, a displacement amount of the connector rear end is large during resonance. In contrast, since the front tube portion 62 is arranged to surround the outer periphery of the wire accommodating portion 24 in the above connector 10, a dimension of the part projecting further rearward than the front end of the front tube portion 62, out of the housing 20, is only the plate thickness of the coupling portion 21 in the connected state, wherefore a rearward projection amount can be suppressed and an increase in the displacement amount of the rear end of the connector 10 can be suppressed during resonance.

Preferably, the receptacle 22 has a tubular shape open forward, and the thickened portion 27 thickened to increase the thickness radially outward is provided on the opening edge part of the receptacle 22.

Since the thickened portion 27 is provided on the opening edge part of the receptacle 22, the center of gravity of the entire connector unit 100 can be located further forward.

Preferably, the thickened portion 27 includes the hand-grip portion 27A increased in thickness toward the front side.

Since the thickened portion 27 includes the hand-grip portion 27A, fingers are easily hooked to the hand-grip portion and the thickened portion 27 can be used as an operating portion during connection when the connector 10 is connected to the mating connector 50. Further, since the center of gravity of the entire connector unit 100 can be located more forward as compared to the case where the hand-grip portion 27A is provided on the rear end of the housing 20, vibration resistance can be more improved.

### OTHER EMBODIMENTS

(1) Although the rubber plug 30 provided with the vibration resistance portion 33 is used in the above embodiment, a rubber plug may not be provided with the vibration resistance portion. Further, a rubber plug may be such that a water stop portion include no lips.

(2) Although the illustrated thickened portion 27 is thickened to increase the thickness radially outward in the opening edge part of the receptacle 22 in the above embodiment, a thickened portion may be thickened to project forward from the opening edge part of the receptacle 22.

(3) Although the thickened portion 27 is illustrated to include the hand-grip portion 27A in the above embodiment, a thickened portion may include no hand-grip portion.

### LIST OF REFERENCE NUMERALS

10: connector, 11: terminal, 12: wire, 13: rubber plug

20: housing, 20A: connection surface, 21: coupling portion, 22: receptacle, 22A: protection wall, 23: tower portion, 23A: cavity, 23B: partition wall, 24: wire accommodating portion, 24A: outer peripheral surface, 25: lock arm, 25A: base end part,

25B: arm portion, 25C: locking portion, 25D: releasing portion, 26: terminal accommodating portion, 26A: locking lance, 26B: outer peripheral surface, 26C: front end part, 27: thickened portion, 27A: hand-grip portion

30: rubber plug, 31: lip, 32: water stop portion, 33: vibration resistance portion,

50: mating connector, 51: mating terminal

60: mating housing, 60A: connection surface, 61: body portion, 61A: outer peripheral surface, 62: front tube portion (mating receptacle), 62A: outer peripheral surface, 62B: inner peripheral surface, 63: rear tube portion, 63A: outer peripheral surface, 64: lock receiving portion, 65: protection wall, 66: flange portion

100: connector unit

1. A connector unit, comprising:
a mating connector including a mating housing; and
a connector including a housing connectable to the mating housing and a rubber plug,
if a connection surface of the mating housing and a connection surface of the housing face each other when the mating housing and the housing are connected and the connection surface sides of the mating housing and the housing are defined as front sides,
the mating housing including a mating receptacle open forward,
the housing including a receptacle externally fittable to the mating receptacle, a tower portion fittable into the mating receptacle and a coupling portion coupling a rear end of the receptacle and a rear end of the tower portion,
the rubber plug being externally fit to the tower portion, the rubber plug being sandwiched between an outer peripheral surface of the tower portion and an inner peripheral surface of the mating receptacle when the mating housing and the housing are connected,
the tower portion including a terminal accommodating portion formed to project further forward than a front end of the receptacle, the terminal accommodating portion accommodating a terminal inside, and a wire accommodating portion connected to a rear side of the terminal accommodating portion, the wire accommodating portion accommodating a wire connected to the terminal inside, and
a front end of the mating receptacle being located in a rear end part of the housing if the mating receptacle is arranged to surround an outer periphery of the wire accommodating portion with the mating housing and the housing connected.

2. The connector unit of claim 1, wherein the receptacle has a tubular shape open forward and a thickened portion thickened to increase a thickness radially outward is provided on an opening edge part of the receptacle.

3. The connector unit of claim 2, wherein the thickened portion includes a hand-grip portion increased in thickness toward a front side.
